(19) United States
(12) Patent Application Publication
(10) Pub. No.: US 2026/0298702 A1
(43) Pub. Date: Oct. 1, 2026

(54) SYSTEMS AND METHODS FOR TRAFFIC MONITORING BASED ON DISTRIBUTED ACOUSTIC SENSING

(71) Applicant: THE HONG KONG POLYTECHNIC UNIVERSITY, Hong Kong (CN)

(72) Inventors: Jingming ZHANG, Hong Kong (CN); Yaxi YAN, Hong Kong (CN); Pak Tao LAU, Hong Kong (CN); Liyang SHAO, Hong Kong (CN); Changyuan YU, Hong Kong (CN)

(21) Appl. No.: 19/577,563

(22) Filed: Mar. 25, 2026

Related U.S. Application Data
(60) Provisional application No. 63/780,699, filed on Mar. 31, 2025.

(51) Int. Cl. G01H 9/00; G06N 3/0455; G06N 3/0464; G08G 1/01

(52) U.S. Cl. CPC G01H 9/004; G06N 3/0455; G06N 3/0464; G08G 1/0116; G08G 1/0125

(57) ABSTRACT

A method for traffic monitoring based on distributed acoustic sensing (DAS) comprises: receiving DAS data from an optical fiber deployed along a roadway having a plurality of lanes, the DAS data being representative of deformations induced by one or more vehicles on the plurality of lanes and obtained from the optical fiber using phase-sensitive optical time-domain reflectometry (φ-OTD); preprocessing the DAS data to generate preprocessed data; applying a deep learning network to the preprocessed data to generate a super-spatial-resolution (SSR) representation of the DAS data; and determining, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

### CROSS-REFERENCE TO RELATED APPLICATIONS

This application claims priority to the U.S. provisional patent application Ser. No. 63/780,699, filed Mar. 31, 2025, hereby incorporated herein by reference as to its entirety.

### FIELD OF THE DISCLOSURE

The present disclosure relates to traffic monitoring based on distributed acoustic sensing.

### BACKGROUND

Intelligent transportation systems (ITS) rely on accurate real-time traffic data to manage congestion, enhance road safety, and support autonomous vehicle navigation. Conventional traffic monitoring technologies include embedded sensors, such as inductive loop detectors, piezoelectric devices, and magnetic sensors, which are installed within or beneath roadway surfaces, as well as non-embedded sensors, such as video cameras, LiDAR, microwave radar, and ultrasonic sensors positioned above or beside roadways. While these technologies provide vehicle count, speed, and classification data, they suffer from limitations including invasive and costly installation requiring lane closures, susceptibility to environmental conditions (e.g., weather, lighting, or occlusion), restricted spatial coverage leading to blind spots, and privacy concerns associated with image-based systems.

New system or method that assists in advancing technological needs and industrial applications in this filed are desirable.

### SUMMARY

One or more embodiments provide a method for traffic monitoring based on distributed acoustic sensing (DAS). The method comprises: receiving DAS data from an optical fiber deployed along a roadway having a plurality of lanes, the DAS data being representative of deformations induced by one or more vehicles on the plurality of lanes and obtained from the optical fiber using phase-sensitive optical time-domain reflectometry (φ-OTDR); preprocessing the DAS data to generate preprocessed data; applying a deep learning network to the preprocessed data to generate a super-spatial-resolution (SSR) representation of the DAS data; and determining, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

One or more embodiments provide a system for traffic monitoring based on distributed acoustic sensing (DAS). The system comprises a DAS interrogator and one or more processors. The DAS interrogator is configured to transmit probing light pulses into an optical fiber deployed along a roadway having a plurality of lanes and to receive backscattered light therefrom using phase-sensitive optical time-domain reflectometry (φ-OTDR) to generate DAS data representative of deformations induced by one or more vehicles on the plurality of lanes. The one or more processors are configured to: preprocess the DAS data to generate preprocessed data; apply a deep learning network to the preprocessed data to generate a super-spatial-resolution (SSR) representation of the DAS data; and determine, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

One or more embodiments provide a non-transitory computer-readable medium storing instructions. The instructions, when executed by one or more processors for traffic monitoring based on distributed acoustic sensing (DAS), cause the one or more processors to: receive DAS data from an optical fiber deployed along a roadway having a plurality of lanes, the DAS data being representative of deformations induced by one or more vehicles on the plurality of lanes and obtained from the optical fiber using phase-sensitive optical time-domain reflectometry (φ-OTDR); preprocess the DAS data to generate preprocessed data; apply a deep learning network to the preprocessed data to generate a super-spatial-resolution (SSR) representation of the DAS data; and determine, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

Other embodiments are also described herein.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The drawings are not to scale, unless otherwise disclosed. Certain parts of the drawings may be exaggerated for explanation purposes and shall not be considered limiting unless otherwise specified.

FIG. 1 depicts a system structure of a typical φ-OTDR system with heterodyne coherent detection according to certain embodiments of the present disclosure, where NLL: narrow linewidth laser; AOM: acousto-optic modulator; EDFA: erbium doped fiber amplifier; FUT: fiber under test; BPD: balanced photodetector; DAQ: data acquisition; DSP: digital signal processing.

FIG. 2 depicts a schematic diagram of vehicle monitoring based on DAS according to certain embodiments of the present disclosure.

FIG. 3A illustrates an exemplary deployment scenario for lane identification in a multi-lane roadway according to certain embodiments of the present disclosure.

FIG. 3B depicts vehicle-induced strain signals in the optical fiber for the vehicle positioned closer to the optical fiber, as shown in FIG. 3A.

FIG. 3C depicts vehicle-induced strain signals in the optical fiber for the vehicle positioned farther from the optical fiber, as shown in FIG. 3A.

FIG. 4A is a flowchart illustrating a method for lane determination for vehicles according to certain embodiments of the present disclosure.

FIG. 4B is a flowchart illustrating preprocessing of DAS data according to certain embodiments of the present disclosure.

FIG. 4C depicts a symmetrical encoder-decoder architecture according to certain embodiments of the present disclosure.

FIG. 5A depicts images before and after application of DeCNN according to certain embodiments of the present disclosure.

FIG. 5B depicts width of strain signals before and after application of DeCNN for one vehicle (vehicle 1) according to certain embodiments of the present disclosure.

FIG. 5C depicts width of strain signals before and after application of DeCNN for another vehicle (vehicle 2) according to certain embodiments of the present disclosure.

FIG. 6 illustrates example lane recognition based on width compression of vehicle-induced fiber strain signals before and after trajectory convergence network (TrajConvNet) according to certain embodiments of the present disclosure: (a) waterfall of vehicle-induced fiber strain signals before TrajConvNet for vehicle 1; (b) vehicle-induced fiber strain signals at a specific time before TrajConvNet for vehicle 1; (c) waterfall of vehicle-induced fiber strain signals after TrajConvNet for vehicle 1; (d) vehicle-induced fiber strain signals at a specific time after TrajConvNet for vehicle 1; (e) waterfall of vehicle-induced fiber strain signals before TrajConvNet for vehicle 2; (f) vehicle-induced fiber strain signals at a specific time before TrajConvNet for vehicle 2; (g) waterfall of vehicle-induced fiber strain signals after TrajConvNet for vehicle 2; (h) vehicle-induced fiber strain signals at a specific time after TrajConvNet for vehicle 2.

FIG. 7 illustrates a system for traffic monitoring based on DAS according to certain embodiments of the present disclosure.

### DETAILED DESCRIPTION

The present disclosure will now be described with reference to the following examples which should be considered in all respects as illustrative and non-restrictive.

Throughout the description and the claims, the words “comprise”, “comprising”, and the like are to be construed in an inclusive sense as opposed to an exclusive or exhaustive sense; that is to say, in the sense of “comprising, but not limited to”.

Furthermore, as used herein and unless otherwise specified, the use of the ordinal adjectives “first”, “second”, etc., to describe a common object, merely indicate that different instances of like objects are being referred to, and are not intended to imply that the objects so described must be in a given sequence, either temporally, spatially, in ranking, or in any other manner.

Example embodiments relate to traffic monitoring based on distributed acoustic sensing.

Many existing technologies are flawed in one aspect or another. For example, traditional traffic sensors are limited by restricted coverage and blind spots—for example, cameras and LiDAR are often occluded by large vehicles—leading to incomplete traffic data and reduced effectiveness of management systems. While mobile sensing approaches, such as vehicle GPS tracking and cellular network-based monitoring, extend coverage, they raise substantial privacy concerns. Distributed acoustic sensing (DAS) has emerged as a promising alternative for traffic monitoring by leveraging existing telecommunication optical fiber infrastructure to detect vehicle-induced vibrations and acoustic perturbations along extensive roadway segments in a non-intrusive manner. DAS systems transform standard optical fibers into continuous sensor arrays capable of monitoring vehicle passage over tens of kilometers with meter-scale spatial resolution. However, conventional DAS approaches are constrained by fundamental hardware limitations, including spatial resolution determined by the optical pulse width, gauge length, and sampling interval, resulting in convolved signals that blur position information and degrade accuracy in dense traffic environments. Prior efforts to improve spatial resolution, such as pulse compression techniques, often increase system complexity and cost through additional hardware components like matched filters or specialized modulators. Moreover, existing DAS-based traffic monitoring methods generally lack reliable vehicle lane identification capabilities, particularly for multi-lane roadways, limiting their utility for precise traffic management, flow optimization, and autonomous driving support in metropolitan settings.

Example embodiments solve one or more problems associated with the existing technologies and provide technical solutions with new designs and improved performance.

Example embodiments provide systems and methods for traffic monitoring based on DAS.

One or more embodiments provide methods and systems traffic monitoring based on DAS using one or more deep learning networks. One or more embodiments achieve super spatial resolution and lane identification of vehicles in DAS based traffic monitoring using deconvolutional neural network (DeCNN).

One or more embodiments provide a vehicle lane identification method for traffic monitoring that integrates DAS with a DeCNN. The method employs an optical fiber infrastructure to detect vehicle-induced acoustic deformations, enabling non-intrusive, continuous monitoring of vehicular activity over extended roadway segments. With the DeCNN architecture, the method achieves super-spatial resolution by mitigating the pulse-width limitations inherent in conventional DAS systems, thereby producing high-resolution DAS traffic monitoring images. Vehicle lane occupancy is then determined by computing a compression ratio of the width of vehicle signals, in conjunction with a physical model of signal propagation. According to one or more embodiments, field experiments conducted in the Hung Hom Cross-Harbour Tunnel demonstrates lane detection accuracy of 94.17%, which is of great significance for urban traffic management, autonomous driving, or smart city applications. This approach overcomes deficiencies in prior DAS-based traffic monitoring techniques by providing reliable multi-lane discrimination, thereby supporting enhanced urban traffic management, road safety, and integration with autonomous vehicle navigation systems.

One or more embodiments provide an advanced signal processing method for accurately identifying vehicle lanes through integration of DAS with deep learning technologies. The method addresses a number of limitations in existing DAS traffic monitoring systems, where constrain spatial resolution and inadequate lane discrimination often result in inaccuracies in vehicle positioning and tracking data. By employing deconvolutional neural networks, the method enhances spatial resolution and enables reliable lane recognition capabilities essential for effective traffic management and road safety. The method overcomes these deficiencies to deliver precise real-time traffic data, thereby supporting autonomous driving systems, optimizing urban traffic flow, and improving infrastructure monitoring. Integration of this technology into smart city frameworks can substantially enhance the performance and efficiency of urban transportation systems.

One or more embodiments provide advanced data preprocessing techniques to enhance the quality of signals acquired from optical fiber DAS systems for vehicle lane identification in traffic monitoring applications. Specifically, the method implements a sequence of preprocessing steps on raw DAS data, including low-pass filtering to isolate quasi-static vehicle-induced deformations while suppressing higher-frequency noise and interference, frequency-domain integration to convert strain rate measurements into accumulated strain profiles, time-domain downsampling to reduce temporal sampling rate and computational overhead, and spatial-domain interpolation to upsample along the fiber axis. These steps collectively mitigate environmental noise and convolution artifacts arising from pulse width limitations, thereby providing cleaner, higher-resolution inputs to downstream processes. In contrast to conventional DAS approaches, which often yield blurred signals insufficient for precise lane discrimination in multi-lane roadways, the disclosed preprocessing pipeline enables robust resolution enhancement, supporting accurate lane detection in real-world urban and tunnel environments.

One or more embodiments employs a DeCNN based on the ResUnet++ framework and achieves significant improvements in spatial resolution and feature extraction compared to traditional convolutional neural networks. This enables superior performance in processing complex data for traffic monitoring. Conventional DAS systems often lack sufficient accuracy and detail capture. The innovative DeCNN architecture delivers higher detection accuracy, thereby enhancing the effectiveness and safety of urban traffic management.

One or more embodiments trains models using synthetic data generated from physical traffic models, significantly reducing reliance on large real-world datasets and lowering the costs and challenges associated with data collection. Acquiring actual traffic data is often time-consuming and expensive, particularly under specialized conditions. Simulation-based training enhances the flexibility and efficiency of model development, making the system more economical and practical to implement.

One or more embodiments provide innovative lane recognition capable of accurately identifying the specific lanes occupied by vehicles-a capability not achieved by existing DAS technologies. This enhances overall monitoring accuracy. Conventional technologies often fail to provide real-time, lane-specific information, limiting their applications in traffic management and autonomous driving. With precise lane recognition, the system more effectively supports autonomous vehicle navigation and intelligent traffic control, thereby improving road safety and management efficiency.

According to one or more embodiments, the deep learning network may employ alternatives other than DeCNN for vehicle lane identification in DAS traffic monitoring. For example, an Xception-based architecture, leveraging depthwise separable convolutions, can provide superior feature extraction efficiency, potentially improving recognition accuracy for complex vibration traces by reducing parameters while maintaining high representational power. Similarly, EfficientNet models, which utilize compound scaling to balance network depth, width, and resolution, offer enhanced accuracy with reduced computational requirements, making them suitable for resource-constrained deployments in real-time traffic data processing. Vision Transformer (ViT) architectures represent another alternative, excelling in global context capture and image understanding tasks compared to purely convolutional networks, thereby potentially increasing the effectiveness of spatial detail reconstruction in DAS waterfall images. Hybrid approaches may also be implemented, such as combining ResNet backbones with recurrent neural networks (RNNs or LSTMs) to better exploit temporal dependencies in sequential vehicle passages, enabling recognition of more complex traffic patterns. Additionally, integrating convolutional neural networks with graph neural networks (GNNs) can incorporate road network topology and structural information, enhancing contextual feature extraction and lane discrimination in multi-lane or intersection scenarios. These alternative architectures, when trained on physics-based simulation data (e.g., Flamant-Boussinesq load models), maintain the core functionality of computing compression ratios from sharpened signal widths, providing flexible extensions to the disclosed system for varied operational environments.

According to one or more embodiments, the deep learning network, such as DeCNN, can be trained using domain adaptation methods as a substitute or complement to purely simulation-based training. Domain adaptation leverages data from related but distinct domains—such as real DAS recordings from different roadways, soil conditions, fiber burial depths, or environmental settings—to fine-tune the model, thereby reducing dependency on extensive labeled real-world traffic datasets while enhancing generalization across varied deployment scenarios. This approach addresses domain shifts between physics-based simulations (e.g., Flamant-Boussinesq models) and actual field conditions, improving robustness to real-world variations like noise profiles or vehicle types without requiring costly on-site data collection. By aligning feature distributions across source and target domains through techniques such as adversarial training or discrepancy minimization, domain adaptation maintains the DeCNN's super-spatial resolution and compression ratio-based lane identification performance, offering greater adaptability for diverse urban, highway, or tunnel environments.

According to one or more embodiments, lane recognition within the DAS traffic monitoring system may incorporate multimodal sensor inputs to improve accuracy and robustness. Specifically, fusion of data from cameras and light detection and ranging (LiDAR) sensors with processed DAS vibration traces enables complementary analysis: visual inputs capture explicit lane markings and environmental context, while LiDAR provides precise 3D spatial mapping, and DAS contributes non-intrusive ground deformation profiles. This integration enhances lane identification reliability under varied conditions, such as poor visibility or dense traffic, by cross-validating signal compression ratios with optical and range-based features.

Other embodiments may utilize deep learning-based image segmentation techniques on DAS spatiotemporal representations (e.g., waterfall plots). Architectures such as Mask R-CNN or U-Net perform pixel-level segmentation to delineate lane-specific vehicle signatures and potential obstacles directly from super-spatial resolution images, achieving fine-grained boundary detection without exclusive dependence on width-based compression ratios. This approach improves overall detection precision in multi-lane scenarios.

Further alternatives combine convolutional neural networks (CNNs) with edge detection algorithms, such as the Canny edge detector. Applying Canny filtering to preprocessed or DeCNN-enhanced DAS traces highlights intensity gradients corresponding to signal edges, which are then processed by the CNN for efficient feature classification and lane assignment. This hybrid method boosts computational efficiency and accuracy by leveraging classical edge cues to augment neural network performance in identifying lane-dependent deformation patterns.

The methods or systems according to one or more embodiments have various applications. One or more embodiments find immediate application in urban road traffic monitoring and management, where the non-intrusive deployment of existing telecommunication optical fibers enables continuous, large-scale detection of vehicle lanes and trajectories in dense metropolitan environments. By providing accurate lane-specific data through super-spatial resolution enhancement and compression ratio analysis, the system supports real-time congestion mitigation, traffic flow optimization, and incident detection without requiring road closures or additional infrastructure.

Additional applications include highway and expressway safety monitoring, where the method's ability to discriminate lanes for large vehicles enhances oversight of high-speed traffic, enabling early warning of lane deviations, overtaking risks, or heavy vehicle positioning.

One or more embodiments support autonomous driving and advanced driver assistance systems (ADAS) by delivering precise, lane-resolved vehicle proximity and movement data to vehicle navigation algorithms, improving situational awareness and safe path planning. Infrastructure condition and road usage analysis also benefit directly, as repeated vehicle load patterns derived from quasi-static deformation profiles allow assessment of pavement wear, load distribution, and long-term structural impacts.

Looking to future applications and extensions, one or more embodiments should be well-suited for integration into broader smart city and intelligent transportation systems, providing foundational lane-level traffic intelligence for centralized control platforms, dynamic signaling, and urban planning. Extensions to multi-sensor fusion platforms may combine DAS outputs with camera, LiDAR, or radar data for enhanced robustness in adverse conditions. The system further enables predictive traffic analytics and decision support through historical compression ratio trends and machine learning forecasts of congestion or anomalies.

Beyond roadway applications, one or more embodiments may extend to other technical fields, including railway monitoring for train positioning and track deformation detection, pipeline and utility corridor monitoring for intrusion or leakage events along buried assets, structural health monitoring of bridges and tunnels via vibration and strain analysis, and perimeter and security monitoring for detecting unauthorized crossings or activities near sensitive boundaries. These diverse applications leverage the advantages of distributed, passive sensing with AI-enhanced resolution, offering scalable, cost-effective solutions across transportation and infrastructure domains.

One or more embodiments relate to the operating principle of DAS. DAS operates on detection of the Rayleigh backscattering light (RBL) arising from elastic scattering due to microscopic inhomogeneities in an optical fiber or sending fiber or sensing optical fiber. The backscattered light retains the same frequency as the incident light, but carries phase information modulated by the optical fiber's external environmental conditions. The phase information can be further demodulated to obtain relevant physical information. Among various DAS implementations, the phase-sensitive Optical Time-Domain Reflectometry (φ-OTDR) technique is the most prevalent due to its high sensitivity to dynamic strain or acoustic perturbations.

Referring to FIG. 1, a typical o-OTDR system commonly employs heterodyne coherent detection because of the simple configuration. The output of a narrow linewidth laser (NLL) source is split into two branches: one branch is used as a local oscillator (LO) reference, and the other is modulated into a sequence of narrow optical pulses and launched into the sensing optical fiber. Acousto-optic modulators (AOMs) are often selected for generating optical pulses due to their high extinction ratio and their ability to automatically introduce a shift in the optical carrier frequency, which facilitates straightforward implementation of heterodyne detection at a receiver. Heterodyne detection requires a high data acquisition sampling rate and therefore doubles the receiver bandwidth. Band-pass sampling can help reduce the requirement of a high data sampling rate to some extent, but it increases the complexity of digital signal processing (DSP). Therefore, homodyne detection can also employed in o-OTDR systems to realize a lower bandwidth requirement for both the photodetectors and the analog-to-digital convertors.

Due to variations in the fiber refractive index caused by inherent inhomogeneities, each optical pulse undergoes Rayleigh scattering and a part of them propagates in the reverse direction, producing the RBL. The total backscattered field received can be modeled as the coherent summation of the RBL fields, which can be expressed as:

$${E}_{R B S} ( t ) = {\sum }_{i = I}^{N} {r}_{i} {e}^{\frac{- α c {τ}_{i}}{n}} rect ( \frac{t - {τ}_{i}}{{T}_{p}} ) {e}^{j [ ( {ω}_{c} + Δ ω ) ( t - {τ}_{i} ) ]} \qquad ( 1 )$$

where rᵢ is the complex scattering coefficient at the i-th scatter, τᵢ is the round-trip time for the scattering site, α is the fiber attenuation coefficient, c is the light velocity in vacuum, n is the refractive index of the fiber core, rect (·) is the rectangular window function defined by the probe pulse width Tₚ, ω_{c} is the angular frequency of the laser and Δω is the frequency shift introduced by the modulator.

The balanced photodetector in the DAS performs optical heterodyne detection, where the backscattered light signal is mixed with the LO signal

$${E}_{L O} ( i ) = {A}_{L O} {e}^{j {ω}_{L O} t} .$$

As ω_{LO}=ω_{c}, the electrical signal output I(t) from the balanced photodetector is proportional to the real part of the interference term:

$$\begin{matrix}I ( t ) ∝ \text{?} \{ {E}_{R B S} ( t ) \cdot {E}_{L O}^{*} ( t ) \} \\ ∝ \text{?} \{ {\sum }_{i = 1}^{N} {r}_{i} {e}^{\frac{- α c {τ}_{i}}{n}} rect ( \frac{t - {τ}_{i}}{{T}_{p}} ) {e}^{j [ Δω ( t - {τ}_{i} ) - {ω}_{c} {τ}_{i} ]} \} \\ ∝ {\sum }_{i = 1}^{N} {r}_{i} {e}^{\frac{- α c {τ}_{i}}{n}} rect ( \frac{t - {τ}_{i}}{{T}_{p}} ) cos [ Δω ( t - {τ}_{i} ) - {ω}_{c} {τ}_{i} ]\end{matrix} \qquad ( 2 )$$

The real-valued output signal has no phase information, so to capture the phase shift, it is converted to complex signal by Hilbert transform. Considering the large number of scatterers and their close proximity, the discrete summation can be approximated as a continuous integral. The DAS is regarded as a linear time-invariant system and the output signal s(t) is expressed as the convolution of the Rayleigh impulse response h(t) with the probing light signal p(t):

$$\begin{matrix}s ( t ) = {\int }_{0}^{{T}_{r}} r ( τ ) {e}^{\frac{- α c τ}{n}} rect ( \frac{t - τ}{{T}_{p}} ) {e}^{j [ Δω ( t - τ ) - {ω}_{c} τ ]} d τ \\ = {\int }_{0}^{{T}_{r}} [ r ( τ ) {e}^{\frac{- α c τ}{n}} {e}^{- j {ω}_{c} τ} ] \cdot [ rect ( \frac{t - τ}{{T}_{p}} ) {e}^{j [ Δω ( t - τ ) ]} ] d τ \\ = {\int }_{0}^{{T}_{r}} h ( τ ) p ( t - τ ) d τ = h ( t ) ⊗ p ( t )\end{matrix} \qquad ( 3 )$$

where ⊗ denotes the convolution operation, h(t) is the Rayleigh impulse response of the fiber to an instantaneous input at each τ and p(t) is the modulated rectangular pulse launched into the fiber. The output signal s(t) can be briefly written as

$$s ( t ) = R ( t ) {e}^{j φ ( t )} \qquad ( 4 )$$

When an external dynamic event induces strain on the sensing fiber, the corresponding fiber section will be stretched or bent. Local variations in the fiber length, the core refractive index or the core geometry can induce measurable phase shifts in the RBL. DAS utilizes these phase shifts to detect external vibrations. Through DSP, the time-varying phase changes (represented as the phase term φ(t) in Eq. (4)) are extracted to reflect external vibrations. Ultimately, signal peaks corresponding to vibration events are displayed in the temporal signal trace.

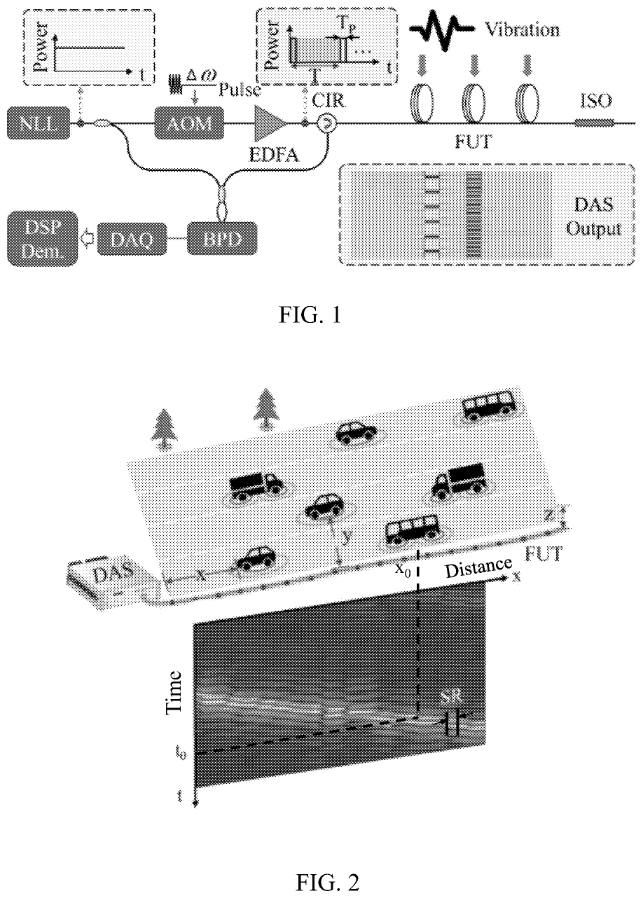

The schematic diagram of vehicle monitoring based on DAS is shown in FIG. 2. Since Rayleigh backscattering signals are generated at different positions with different round-trip time during the forward propagation of optical pulses, the time delay T between the signal peak and the near-end of the sensing fiber is related to the position of the external event along the sensing fiber x as:

$$x = \frac{c T}{2 n} \qquad ( 5 )$$

Due to the convolution operation, the spatial resolution is determined by the width of the optical pulses as SR=cTₚ/2n. The localization of passing vehicles is achieved through the time-of-flight principle of optical time domain reflectometry (OTDR) techniques. By aligning all the time to distance-mapped signal traces along the time axis, a waterfall plot displaying the trajectories of moving vehicles can be generated.

Despite its simplicity, classical DAS that employs single-frequency optical pulses faces the trade-off between the spatial resolution and the Rayleigh backscattering signal power. Therefore, chirp pulse-based DAS is frequently employed to extend the sensing distance and improve the spatial resolution.

One or more embodiments provide a physical model for sensing passing vehicles. When a vehicle passes over a roadway, it generates two primary types of waves. The first type consists of the relatively high-frequency vibrational waves resulting from friction between the tires and the roadway surface. These waves are dispersive and attenuate rapidly; therefore, they are less suitable for traffic monitoring. The second type is the mechanical waves in the Earth's near surface, which are generated by deformation caused by the load exerted by the vehicle on the roadway surface. It includes Primary Waves, Secondary Waves, and Rayleigh Waves. According to elastic wave theory, the energy of Rayleigh waves is concentrated on the roadway surface, enabling effective detection by optical fibers typically buried at shallow depths of a few meters. Characterized by low frequency and minimal attenuation, Rayleigh waves can propagate over relatively long distances. In DAS systems, they exhibit a compact signal pattern, making them the most prominent component for traffic monitoring applications.

To model the ground deformation caused by moving vehicles, each moving vehicle is represented as four moving point loads on the ground, which can be approximated as an isotropic semi-infinite elastic half-space. Since the vehicle's speed is much slower than the Rayleigh wave velocity in the ground (about 50-300 m/s for shallow waves less than 100 m depth), the process of the vehicle load inducing strain can be regarded as a quasi-static process. And the Flamant-Boussinesq approximation theory is well-suited for modeling this process. In the Cartesian Coordinate System, it is assumed that x is parallel to the optical fiber, y is perpendicular to the optical fiber, and z is perpendicular to the surface, which is shown in FIG. 2. The ground displacement field uᵢ, i∈x, y, z is given by the following:

$${u}_{i} = \frac{F}{4 π μ} [ \frac{{d}_{z} {d}_{i}}{{r}^{3}} + ( 3 - 4 v ) \frac{{δ}_{i z}}{r} - \frac{( 1 - 2 v )}{r + {d}_{z}} ( {δ}_{z i} + \frac{{d}_{i}}{r} ) ] \qquad ( 6 )$$

where F is the force of the applied point load, μ is the shear modulus of the material, dᵢ is the distance from the sensing point to the load point in i direction,

$$r = \sqrt{{d}_{x}^{2} + {d}_{y}^{2} + {d}_{Z}^{2}}$$

is the radial distance, ν is the Poisson's ratio of the material and δ is the Kronecker sign.

Assuming that the optical fiber is laid completely parallel to the roadway, then the strain sensed by the fiber is only determined by the displacement in the direction of the fiber uₓ (δ_{xz}=0, δ_{zx}=0) that can be simplified as:

$${u}_{x} = \frac{F}{4 πμ} \frac{x}{{r}^{2}} [ \frac{z}{r} + \frac{2 v - 1}{1 + \frac{z}{r}} ] \qquad ( 7 )$$

where x is the distance from the sensing point to the load point along the fiber, z is the buried depth.

According to the above principle of DAS, DAS measures the longitudinal strain rate (\dot{ε}) over a gauge length L that is given by the following:

$$\dot{ε} = \frac{{\dot{u}}_{x} ( x + \frac{L}{2} ) - {\dot{u}}_{x} ( x - \frac{L}{2} )}{L} \qquad ( 8 )$$

where \dot{u}ₓ is the time derivative of uₓ.

Based on Eq. (7) and (8), it can be inferred that the measured displacement in the direction of the fiber uₓ is linearly related to the vehicle's weight, which is reflected by F in Eq. (7). As the vehicle moves forward, it sequentially induces responses along the optical fiber. Based on the OTDR technology, the real-time position of the vehicle can be obtained, enabling the calculation of its speed. Moreover, the collected signal represents the superposition of the vibration signals caused by all wheels of all vehicles at that time, and that makes it possible to detect axle and wheelbase configurations.

One or more embodiments provide lane identification for a plurality of vehicles on a roadway having a plurality of lanes. While in one or more embodiments as described herein only two lanes are illustrated, it will be understood by those skilled in the art that this is for illustrative purpose only and according to some embodiments, the number of lanes can be one, or more than two, such as three, four, etc.

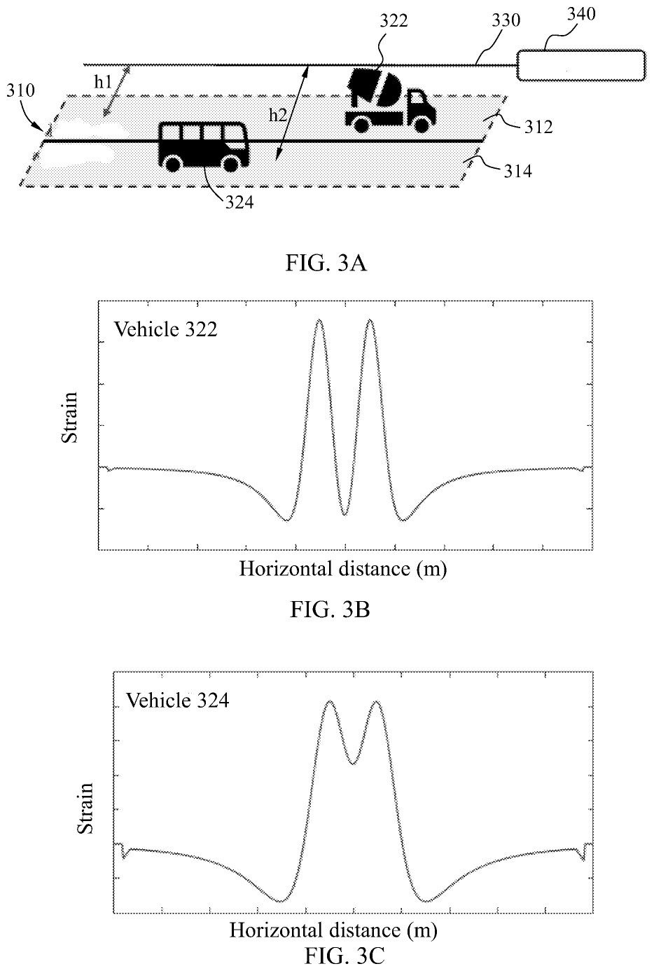

FIG. 3A illustrates an exemplary deployment scenario for lane identification in a multi-lane roadway according to certain embodiments of the present invention. By way of example and for illustrative purpose only, the roadway 310 has two lanes 312, 314. Two vehicles 322, 324 are shown traveling in adjacent lanes, with the vehicle 322 positioned in the lane 312 closer to an optical fiber 330 (horizontal distance h1) and the vehicle 324 in a farther lane 314 (horizontal distance h2). In the illustrated embodiments, the horizontal distance is defined as the perpendicular distance from the center of the vehicle lane to the optical fiber in a plane parallel with the surface of the roadway. It will be appreciated that the horizontal distance may be defined or measured in alternative manners according to practical needs.

The optical fiber 330 can be buried parallel to the roadway 310 and extends along the longitudinal direction of the roadway. This can be implemented, for example, by utilizing dark fibers in existing telecommunication cables laid along one side of the road. The optical fiber 330 is connected to an DAS system 340. The DAS system can include one DAS interrogator connected to the sensing optical fiber, with the interrogator housing key components such as a narrow-linewidth laser, pulse modulator (e.g., acousto-optic modulator), optical amplifier (e.g., erbium-doped fiber amplifier), optical circulator or coupler, photodetector (e.g., balanced photodetector), data acquisition unit, and digital signal processing unit, etc. Vehicle-induced ground deformations propagate to the optical fiber, producing detectable strain signals whose spatial characteristics vary with horizontal distance.

FIGS. 3B and 3C depict vehicle-induced strain signals in the optical fiber for the vehicles. In FIG. 3B, the strain signals for vehicle 322 (closer lane, horizontal distance approximately 4 m) displays a narrower, more peaked profile, reflecting localized deformation from proximity to the optical fiber. In contrast, FIG. 3C shows the strain signal for vehicle 324 (farther lane, horizontal distance approximately 8 m), characterized by a wider, more diffuse profile resulting from increased horizontal distance. These differences arise from the physical propagation of vehicle load according to elastic half-space models (e.g., Flamant-Boussinesq approximation), where closer lanes produce stronger, more confined strain fields. The system's gauge length (e.g., 3.75 m) and pulse width (e.g., 3.5 m) define the baseline spatial resolution, with the gauge length typically set slightly greater than the pulse width to optimize sensitivity while maintaining resolution. As the horizontal distance increases, the detected DAS signal exhibits a wider spatial profile due to broader propagation of the quasi-static load-induced deformation in the subsurface.

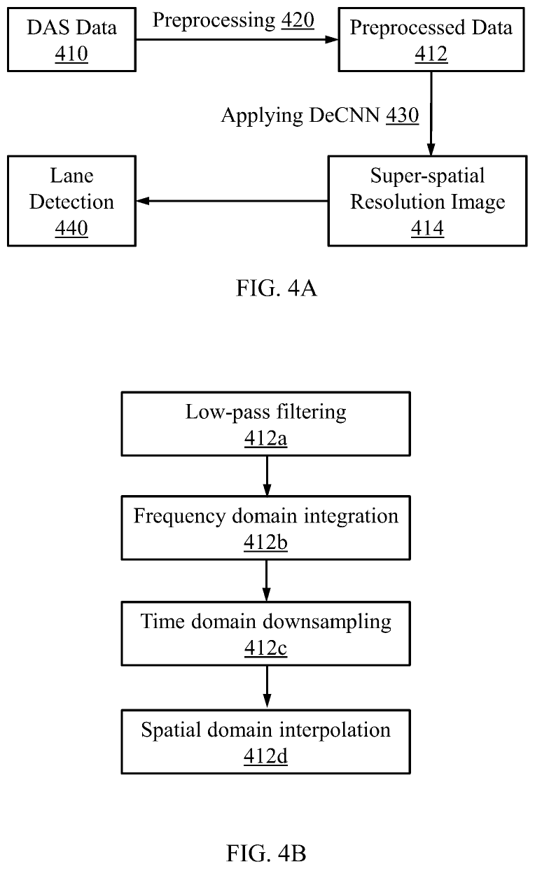

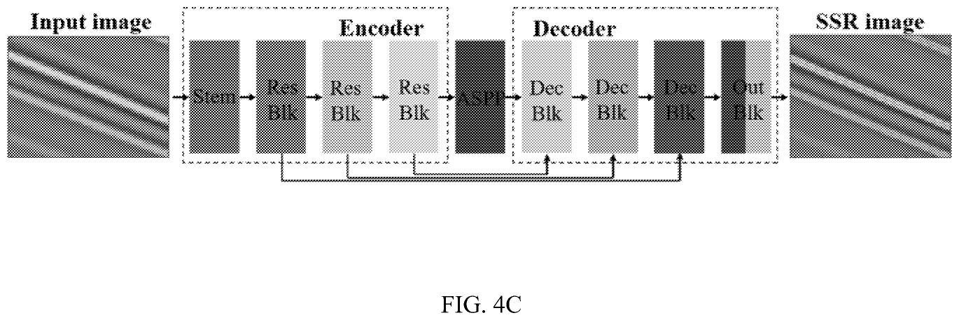

Referring to FIG. 4A, FIG. 4B, and FIG. 4C, one or more embodiments provide a method for enhancing system's spatial resolution using a deep learning network, such as a DeCNN.

As illustrated, raw DAS data 410, e.g. acquired from a phase-sensitive optical time-domain reflectometry (φ-OTDR) system, is first subjected to a preprocessing 420 to generate processed data 412. An example preprocessing stage is illustrated in FIG. 4B and comprises a sequence of operations applied to raw DAS data to prepare it for input to a deep learning network, such as a DeCNN.

Block 412a states low-pass filtering. For example, Block 412a performs low-pass filtering to isolate quasi-static vehicle-induced deformations while suppressing higher-frequency components, such as dynamic vibrations, acoustic noise, or environmental interference. This filtering step extracts the low-frequency strain signatures dominated by vehicle weight propagation (typically below approximately 1-2 Hz), producing clearer spatiotemporal representations that emphasize the broad deformation profiles critical for lane-dependent width analysis.

Block 412b states frequency domain integration. For example, Block 412b applies frequency-domain integration to convert the native strain rate output of the φ-OTDR DAS interrogator into accumulated strain signals. By transforming the filtered data to the frequency domain (e.g., via fast Fourier transform), dividing by the imaginary frequency component (with appropriate handling of DC and low-frequency terms to avoid drift), and performing an inverse transform, this operation recovers interpretable strain profiles that more accurately reflect the physical elastic response of the subsurface to vehicle loads, in accordance with models such as the Flamant-Boussinesq approximation.

Block 412c states time domain downsampling. For example, Block 412c conducts time-domain downsampling, reducing the temporal sampling rate of the integrated strain data by decimation or averaging after anti-aliasing ensured by prior low-pass filtering. This step decreases data volume and computational requirements while preserving the slow-varying quasi-static characteristics essential for vehicle passage events, optimizing the dataset for efficient processing by the subsequent neural network without introducing significant information loss.

Block 412d states spatial domain interpolation. For example, Block 412d executes spatial-domain interpolation, upsampling the data along the fiber axis to a finer spatial grid (e.g., 0.125 m intervals). Techniques such as linear, spline, or sinc interpolation can be employed to increase sampling density, providing a denser input representation that enhances the deconvolutional neural network's ability to achieve super-spatial resolution beyond the hardware-imposed pulse width and gauge length constraints. The output of this preprocessing stage is a refined, balanced dataset primed for super-resolution enhancement, enabling precise measurement of original signal widths and subsequent compression ratio calculation for reliable lane determination.

Referring again to FIG. 4A, the preprocessed data 412 is then input to a DeCNN 430 to generate super-spatial resolution (SSR) image 414 to be used for lane detection 440. The DeCNN 430, for example, can be implemented using a ResUnet++ architecture with symmetrical encoder-decoder structure, residual blocks, attention mechanisms, and Atrous Spatial Pyramid Pooling for multi-scale feature extraction (FIG. 4C). Trained on physics-based synthetic data (e.g., generated from Flamant-Boussinesq load models and one-dimensional Rayleigh scattering simulations), the DeCNN performs super-spatial resolution enhancement, sharpening blurred vibration traces beyond hardware pulse-width and gauge-length limitations to produce a high-resolution super-spatial resolution image.

Referring to FIG. 4C, the DeCNN is based on a ResUnet++ framework featuring a symmetrical encoder-decoder structure. An input image, representing a preprocessed DAS spatiotemporal waterfall plot of vehicle-induced vibration traces, is fed into the encoder portion. The encoder begins with a stem block (Stem Blk) that applies multiple convolutions, batch normalization, ReLU activation, and Squeeze-and-Excitation (SE) attention to extract and enhance initial low-level features. This is followed by a series of residual blocks (Res Blk), each incorporating residual connections and attention mechanisms to enable deeper feature representation while mitigating vanishing gradient issues.

At the bottleneck of the encoder, an ASPP module employs parallel convolutions with varying dilation rates to capture multi-scale contextual information from the compressed feature maps, improving the network's ability to model diverse spatial extents of vehicle deformation signals. The decoder portion symmetrically mirrors the encoder, consisting of multiple decoder blocks (Dec Blk) that combine upsampled features from corresponding encoder layers via skip connections, attention mechanisms, residual connections, and deconvolution (transposed convolution) operations to progressively reconstruct spatial details. An output block (Out Blk) performs final multi-scale feature aggregation and channel optimization to generate the SSR image—a sharpened, high-resolution version of the input waterfall plot exhibiting narrower, more defined vehicle signal traces.

This encoder-decoder design enables the DeCNN to recover fine-grained details beyond the hardware-limited spatial resolution of raw DAS data, transforming blurred original widths into compressed widths suitable for accurate compression ratio calculation and lane determination. Trained on synthetic data derived from physical propagation models (e.g., Flamant-Boussinesq approximation), the network effectively amplifies lane-dependent differences in signal profiles, supporting robust performance in real-world multi-lane traffic scenarios.

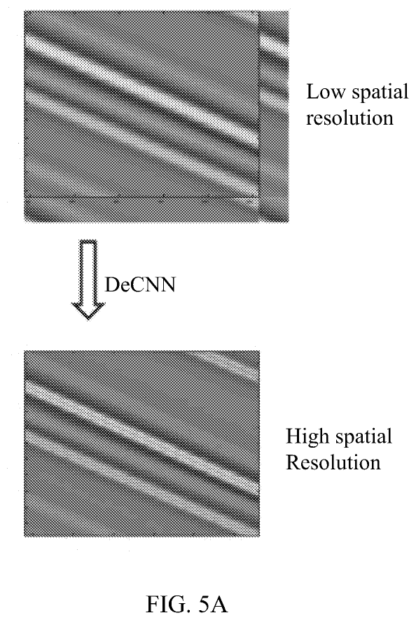

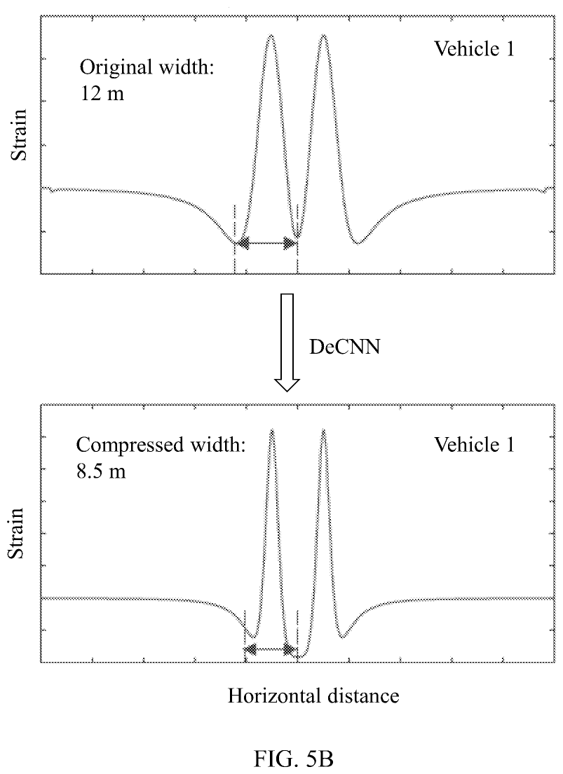

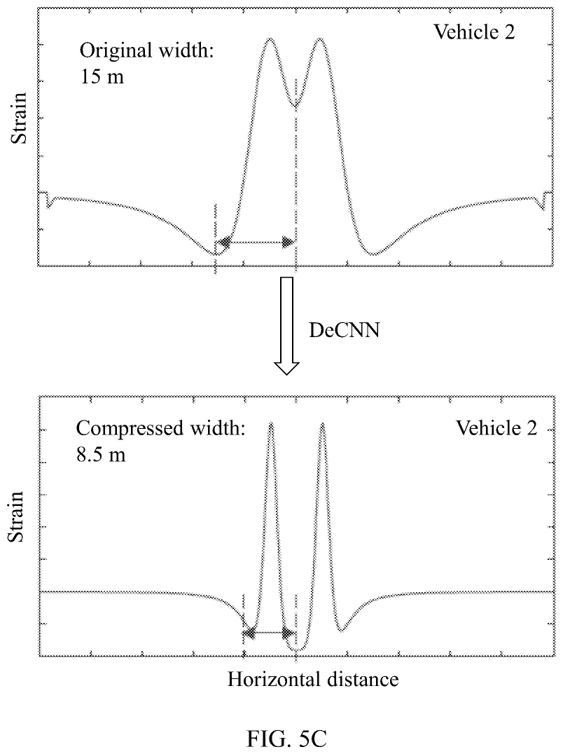

FIG. 5A depicts images before and after application of DeCNN according to certain embodiments of the present disclosure. FIG. 5B depicts width of strain signals before and after application of DeCNN for one vehicle (vehicle 1). FIG. 5C depicts width of strain signals before and after application of DeCNN for another vehicle (vehicle 2).

For the two vehicles, the upper portion of the figure shows a low spatial resolution DAS spatiotemporal waterfall plot (upper image, FIG. 5A), characterized by broad, blurred vehicle signal traces (upper graphs, FIG. 5B and FIG. 5C) due to pulse width and gauge length constraints. After processing through the DeCNN, the corresponding high spatial resolution waterfall plot (lower image, FIG. 5A) exhibits sharpened, narrower traces with enhanced detail and contrast (lower graphs, FIG. 5B and FIG. 5C), enabling precise identification of lane-dependent signal characteristics.

Specifically and in the illustrated examples, for Vehicle 1, the original signal width measured from the pre-DeCNN (low-resolution) trace is 12 m, while the DeCNN-enhanced trace yields a compressed width of 8.5 m. For Vehicle 2, the original width is 15 m, compressed to 8.5 m after DeCNN processing. The compression ratio is defined as (Original Width−Compressed Width)/Original Width, resulting in a ratio of approximately 0.29 for Vehicle 1 and 0.43 for Vehicle 2. As indicated, a smaller compression ratio corresponds to a vehicle in the lane closer to the sensing fiber, reflecting differences in the relative sharpening achieved by the DeCNN—closer vehicles exhibit inherently less blurred original profiles due to more localized deformation propagation, requiring comparatively less enhancement to reach the recovered high-resolution width. This ratio-based metric, applied with an appropriate threshold, enables reliable lane discrimination for large vehicles in multi-lane roadways or tunnels, as validated in field experiments demonstrating high accuracy.

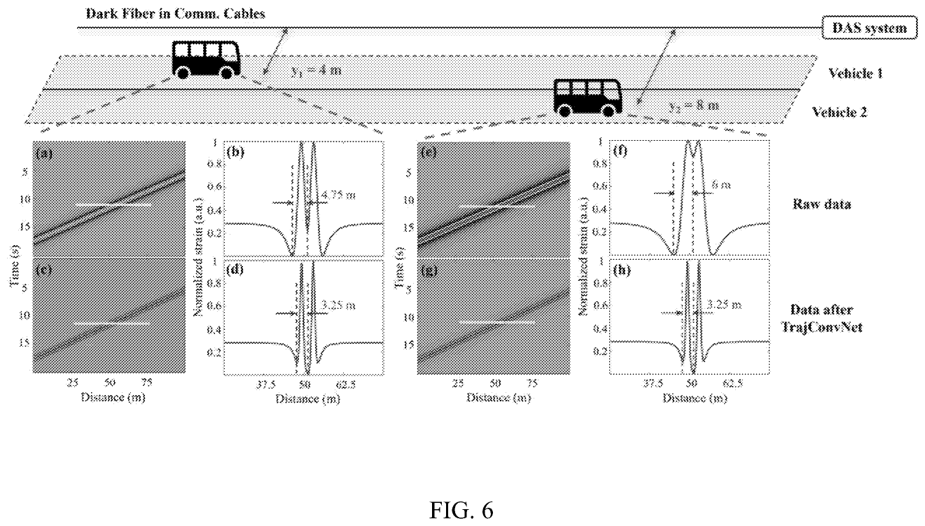

FIG. 6 illustrates example lane recognition based on width compression of vehicle-induced fiber strain signals before and after trajectory convergence network (TrajConvNet) according to certain embodiments of the present disclosure. Vehicle 1 is disposed on one lane at a horizontal distance y₁=4 m from the fiber, and Vehicle 2 is disposed on the other lane at a horizontal distance y₂=8 m. Vehicle loads induce quasi-static ground deformations that propagate to the buried fiber, producing detectable strain profiles whose spatial width increases with greater horizontal distance due to broader subsurface dispersion.

In DAS-based vehicle monitoring, the spatial width of the vehicle-induced strain rate signal recorded by DAS tends to increase as the horizontal distance between the vehicle and the optical fiber increases. However, this signal width is also influenced by multiple parameters, such as the force of the applied point load, the shear modulus of the material and the Poisson's ratio of the material. Consequently, relying solely on the observed signal width does not provide sufficient reliability for accurate lane distinction. The present inventors have found that a deep learning network, particularly a DeCNN, can be used to compress the width of original vehicle-induced signals with different horizontal distances into the ideal width of vehicle-induced signals detected by point sensors (where the gauge length approaches 0) without horizontal distance (y=0). Based on the compression ratio of the signal width before and after the processing of deep learning networks, the lane of the vehicle can be recognized accordingly.

An example lane recognition is shown in FIG. 6. A trajectory convergence network (TrajConvNet) is tailored for the lane recognition application. In this disclosure, TrajConvNet refers to an implementation of the DeCNN. In this example, to optimize the compression ratio result of the signal width before and after TrajConvNet, the strain signal, which is the time domain integration of the vehicle-induced strain rate signal, is used for analysis. The TrajConvNet used for width compression is built on a ResUNet++ framework.

As illustrated, panels (a)-(d) correspond to the closer vehicle (vehicle 1, y₁=4 m), while panels (e)-(h) correspond to the farther vehicle (vehicle 2, y₂=8 m). Panels (a) and (e) show spatiotemporal waterfall plots of raw or preprocessed DAS data, with slanted trajectories indicating vehicle movement over time (vertical axis) and distance along the fiber (horizontal axis). Panels (b) and (f) display normalized strain versus distance, revealing narrower peak widths for the closer vehicle (e.g., ~4.75 m full width) compared to the farther vehicle (~6 m), reflecting more localized deformation. Panels (c) and (g) present time-domain views with relatively flat profiles over distance. Panels (d) and (h) show post-processing normalized strain peaks, sharpened to ~3.25 m in both cases after super-spatial resolution enhancement, demonstrating the deconvolutional neural network's ability to recover consistent high-resolution widths regardless of original blurring.

This comparison highlights how raw DAS signals from farther lanes exhibit wider, more diffuse profiles due to increased horizontal propagation, while closer lanes produce inherently sharper signatures. The DeCNN-based super-resolution compresses these widths differentially, yielding higher compression ratios for farther vehicles and enabling threshold-based lane discrimination. Such physics-aligned behavior, informed by elastic load models (e.g., Flamant-Boussinesq), supports accurate multi-lane identification for large vehicles in real-world deployments without additional hardware.

According to one or more embodiments, the training dataset is generated through simulation based on the DAS vehicle sensing model described in Eq. (7), which covers the variations in DAS vehicle signals caused by different horizontal vehicle-to-fiber distances (lanes). This dataset also considers three-dimensional fiber deployment locations, Poisson's ratios of road materials, lane widths and various physical characteristics of vehicles such as wheelbase, weight, and speed variations. The simulated strain signals at varying horizontal vehicle-to-fiber distances are paired with the ideal strain signals from vehicles directly passing over a point sensor to serve as training samples for the TrajConvNet.

The compression ratio of signal width before and after TrajConvNet is quantified as:

$$R = \frac{{W}_{0} - W}{{W}_{0}}$$

where W₀ denotes the spatial width of the original strain signal, and W is the compressed width.

The strain signals produced by vehicles closer to the optical fiber are minimally affected by wave propagation, resulting in smaller compression ratios. In contrast, vehicles further from the fiber exhibit larger compression ratios. Based on the actual situation, a predetermined threshold can be set to effectively determine the lane in which a vehicle is traveling. To verify the effectiveness of this lane detection method, DAS signals of 103 large vehicles in a tunnel are collected. The results are shown in Table. 1 as below. Through video verification, the lane positions of 97 vehicles are accurately identified, resulting in a lane detection accuracy rate exceeding 94%.

TABLE 1
THE LANE RECOGNITION RESULTS

| | Total | Correct | Accuracy |
|---|---|---|---|
| Lane | samples | predictions | (%) |
| Right | 71 | 67 | 94.37 |
| Left | 32 | 30 | 93.75 |
| Total | 103 | 97 | 94.17 |

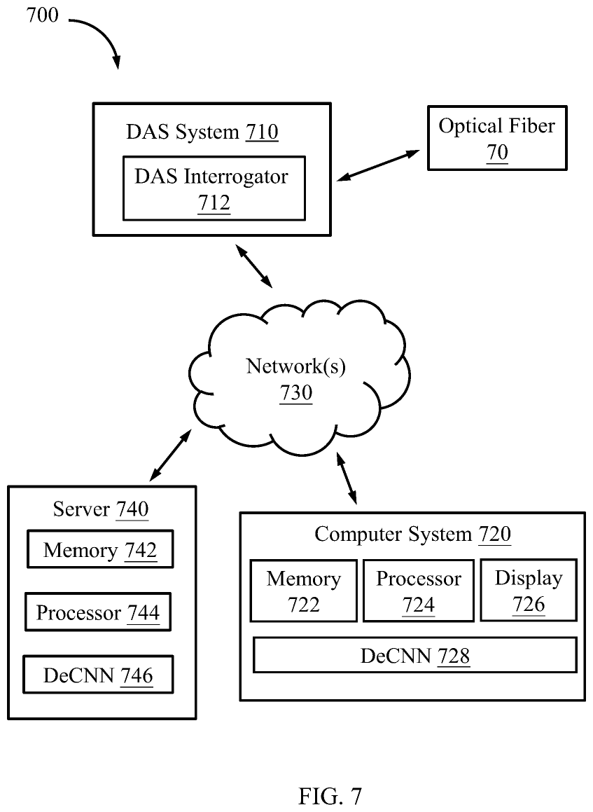

FIG. 7 illustrates a system 700 for traffic monitoring based on DAS according to certain embodiments of the present disclosure. The system 700 can implement one or more methods with reference to one or more embodiments as described herein. For example, the system 700 can facilitate or achieve super spatial resolution and lane identification for vehicles in DAS based traffic monitoring using deconvolutional neural network.

As illustrated, the system 700 comprises a DAS system 710 including a DAS interrogator 712 for communicating with an optical fiber 70, a computer system 720 that communicates with the DAS system 710 via one or more networks 730.

The networks 730 may comprise one or more of a cellular network, the Internet, a local area network (LAN), a personal area network (PAN), a home area network (HAN), and/or other public and/or private networks. Additionally, the computer system need not communicate with the DAS interrogator or processing unit through a network. For example, the computer system and the DAS system may be directly coupled via one or more wired connections (e.g., Ethernet, USB, or fiber optic links). As another example, they may communicate directly using a wireless protocol, such as Bluetooth, near-field communication (NFC), Wi-Fi, or other suitable wireless communication protocols.

The computer system 720 may comprise one or more computing devices, such as a laptop computer, desktop computer, server, embedded computer, single-board computer, tablet, smartphone, or any other suitable computing device capable of performing one or more of the functions or methods described herein. In some embodiments, the computer system may comprise a plurality of computing devices that are co-located or geographically distributed and configured to communicate with one another over one or more wired or wireless networks, thereby collectively performing one or more of the functions or methods described herein (e.g., distributed processing for data preprocessing, deconvolutional neural network inference, compression ratio calculation, and/or lane determination).

As illustrated, the computer system 720 comprises a non-transitory computer-readable medium (CRM) or memory 722, a processing unit or processor 724 (such as one or more processors, microprocessors, and/or microcontrollers), a display 726 and DeCNN 728.

The computer system 720 is configured to receive DAS data from the DAS system 712 (e.g., raw or partially preprocessed vibration/strain rate traces), store the received data in the memory 722, process the stored data using the processor 724—including executing the deconvolutional neural network (DeCNN) 728 to generate super-spatial-resolution traces and compute compression ratios—and display the processing results (e.g., high-resolution DAS images, vehicle signal widths, compression ratios, and/or determined lane information) on the display 726 for user review, parameter adjustment, and/or other operations.

The memory 722 stores executable instructions that, when executed by the processor 724, cause the computer system 720 to perform one or more of the operations or methods described herein (e.g., receiving and preprocessing DAS data, executing the deconvolutional neural network (DeCNN) 728 to generate super-spatial-resolution traces, computing compression ratios, and determining vehicle lane information). The DeCNN 728 comprises a trained neural network model (e.g., based on a ResUnet++ architecture) that enhances the spatial resolution of vehicle-induced vibration/strain rate signals in DAS data beyond the fundamental physical limits imposed by the system's pulse width and gauge length. This enables accurate lane determination that is not reliably achievable with conventional DAS signal processing techniques, thereby providing a specific improvement to the functioning of the computer system itself in the technical field of distributed acoustic sensing for traffic monitoring.

The display 726 is configured to visually present the processing results generated by the computer system 720, including but not limited to high-resolution DAS traces, super-spatial-resolution images produced by the DeCNN 728, original and compressed vehicle signal widths, calculated compression ratios, and determined lane information for detected vehicles. In some embodiments, the display 726 comprises a graphical user interface (GUI) that enables user interaction with the system. For example, the GUI may allow a user to perform actions such as reviewing real-time or historical traffic monitoring data, selecting specific vehicle events or regions of interest for detailed analysis, adjusting operational parameters (e.g., the compression ratio threshold for lane discrimination, filtering settings, or display options), manually confirming or correcting automated lane determinations, zooming/panning on spatiotemporal DAS images, or initiating data export/recording. Such interactive capabilities facilitate operator oversight, system calibration, and integration with broader traffic management platforms, thereby enhancing the practical utility of the invention in field deployments (e.g., tunnel or roadside monitoring stations).

In some embodiments, the system 700 comprises a server 740. The server 740 can be a local computer server or a cloud computer server. The server 740 comprises one or more components of computer readable medium (CRM) or memory 742, a processing unit or processor 744 (such as one or more processors, microprocessors, and/or microcontrollers), and a DeCNN 746. The server 740 communicates with the DAS system 710 and the computer system 720 over the networks 730. The server 740 can retrieve data and perform one or more methods as described herein and send the results to the computer system 720 for output, storage, review, and adjustment, etc. In some embodiment, the server 740 can be connected to local interfaces such as an iPad, a tablet, a smartphone, a display monitor with keyboard and mouse for adjustment. In some embodiment, the server 740 can incorporate artificial intelligence (AI) functions and use the data to develop machine learning algorithms for programming the TRF schedules, thereby to improve the experimental study on rodents.

In some embodiments, the system 700 further comprises a server 740, which may be a local server (e.g., an on-site or edge computing server) or a remote/cloud-based server. The server 740 comprises one or more computer-readable media (CRM) or memory 742, one or more processing units or processors 744 (e.g., CPUs, GPUs, microprocessors, and/or microcontrollers), and DeCNN 746 configured to process DAS data as described herein. The server 740 can be communicatively coupled to the DAS system 710 and/or the computer system 720 via one or more networks 730. In operation, the server 740 may retrieve raw or preprocessed DAS data from the DAS system 710, perform one or more of the methods described herein (e.g., executing the DeCNN 746 to generate super-spatial-resolution traces, compute compression ratios, and determine vehicle lane information), and transmit the processing results to the computer system 720 for storage, display, further analysis, user review, and/or parameter adjustment. In certain embodiments, the server 740 may also be directly connected to one or more local user interfaces, such as a tablet (e.g., iPad), smartphone, touchscreen monitor, or display with keyboard and mouse, to enable on-site configuration, real-time monitoring, manual overrides, or system calibration.

It will further be appreciated that any of the features in the above embodiments of the disclosure may be combined together and are not necessarily applied in isolation from each other. Similar combinations of two or more features from the above described embodiments or preferred forms of the disclosure can be readily made by one skilled in the art.

Unless otherwise defined, the technical and scientific terms used herein have the plain meanings as commonly understood by those skill in the art to which the example embodiments pertain. It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A method for traffic monitoring based on distributed acoustic sensing (DAS), the method comprising:
receiving DAS data from an optical fiber deployed along a roadway having a plurality of lanes, the DAS data being representative of deformations induced by one or more vehicles on the plurality of lanes and obtained from the optical fiber using phase-sensitive optical time-domain reflectometry (φ-OTDR);
preprocessing the DAS data to generate preprocessed data;
applying a deep learning network to the preprocessed data to generate a super-spatial-resolution (SSR) representation of the DAS data; and
determining, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

2. The method of claim 1, wherein preprocessing the DAS data comprises:
low-pass filtering to isolate quasi-static deformations;
frequency domain integration to convert raw DAS data to integrated strain;
time domain downsampling; and
spatial domain interpolation.

3. The method of claim 1, wherein the deep learning network comprises one or more networks selected from a group consisting of a deconvolutional neural network (DeCNN), Xception, EfficientNet, Vision Transformer, a combination of ResNet and RNN, and a combination of CNN and GNN.

4. The method of claim 1, wherein the deep learning network comprises a deconvolutional neural network (DeCNN), and wherein applying the deep learning network comprises: processing the preprocessed data through a symmetrical encoder-decoder architecture including:
a stem block applying multiple convolutions, batch normalization (BN), ReLU activation, and Squeeze-and-Excitation (SE) attention to extract initial features;
one or more ResNet blocks integrating residual connections with attention mechanisms to generate deeper feature representations;
an Atrous Spatial Pyramid Pooling (ASPP) module applying convolutions with varying dilation rates for multi-scale context capture;
one or more decoder blocks combining attention, residual connections, and upsampling to reconstruct spatial details; and
an output block performing multi-scale aggregation and channel optimization to produce refined feature maps.

5. The method of claim 4, wherein the symmetrical encoder-decoder architecture is based on a ResUnet++ architecture.

6. The method of claim 1, wherein the compression ratio is calculated by:
$$R = \frac{{W}_{0} - W}{{W}_{0}}$$
wherein R denotes the compression ratio, W₀ denotes spatial width of an original stain signal, and W denotes a compressed width.

7. The method of claim 1, wherein determining the specific lane comprises: comparing the compression ratio to a predetermined threshold.

8. The method of claim 4, wherein the DeCNN is trained using simulated training data generated from a physical model.

9. The method of claim 8, wherein the physical model comprises a Flamant-Boussinesq approximation for vehicle-induced ground deformation and a one-dimensional Rayleigh scattering model for propagation of DAS signals in the optical fiber.

10. The method of claim 1, further comprising upsampling the preprocessed data to a spatial interval finer than a gauge length or spatial sampling interval of a DAS system prior to applying the deep leaning network.

11. A system for traffic monitoring based on distributed acoustic sensing (DAS), the system comprising:
a DAS interrogator configured to transmit probing light pulses into an optical fiber deployed along a roadway having a plurality of lanes and to receive backscattered light therefrom using phase-sensitive optical time-domain reflectometry (φ-OTDR) to generate DAS data representative of deformations induced by one or more vehicles on the plurality of lanes; and
one or more processors configured to:
preprocess the DAS data to generate preprocessed data;
apply a deep learning network to the preprocessed data to generate a super-spatial-resolution (SSR) representation of the DAS data; and
determine, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

12. The system of claim 11, wherein the deep learning network comprises a deconvolutional neural network (DeCNN).

13. The system of claim 12, wherein the one or more processors are further configured to train the DeCNN using simulated training data generated from a physical model including a Flamant-Boussinesq approximation for vehicle-induced ground deformation and a one-dimensional Rayleigh scattering model for propagation of DAS signals in the optical fiber.

14. The system of claim 12, wherein the DeCNN comprises a symmetrical encoder-decoder architecture based on a ResUnet++ architecture and comprising a stem block, one or more ResNet blocks with attention, an Atrous Spatial Pyramid Poling (ASPP) module, one or more decoder blocks with upsampling and residual connections, and an output block for multi-scale aggregation.

15. The system of claim 12, wherein the compression ratio is calculated by:
$$R = \frac{{W}_{0} - W}{{W}_{0}}$$
wherein R denotes the compression ratio, W₀ denotes spatial width of an original stain signal, and W denotes a compressed width.

16. The system of claim 11, wherein the one or more processors are further configured to perform:
low-pass filtering to isolate quasi-static deformations;
frequency domain integration to convert raw DAS data to integrated strain;
time domain downsampling; and
spatial domain interpolation.

17. The system of claim 11, wherein the one or more processors are further configured to output the determined specific lane for use in at least one of urban traffic management, autonomous vehicle navigation, or road safety monitoring.

18. A non-transitory computer-readable medium storing instructions that, when executed by one or more processors for traffic monitoring based on distributed acoustic sensing (DAS), cause the one or more processors to:
receive DAS data from an optical fiber deployed along a roadway having a plurality of lanes, the DAS data being representative of deformations induced by one or more vehicles on the plurality of lanes and obtained from the optical fiber using phase-sensitive optical time-domain reflectometry (φ-OTDR);
preprocess the DAS data to generate preprocessed data;
apply a deep learning network to the preprocessed data to generate a super-spatial-resolution (SSR) representation of the DAS data; and
determine, based on the SSR representation, a specific lane occupied by at least one vehicle among the plurality of lanes by calculating a compression ratio of a width of a vehicle-induced signal in the SSR representation relative to a corresponding width in the preprocessed data, wherein the compression ratio is a function of a horizontal distance from the specific lane to the optical fiber.

19. The non-transitory computer-readable medium of claim 18, wherein the deep learning network comprises a deconvolutional neural network (DeCNN), and wherein the one or more processors are further caused to:
train the DeCNN using simulated training data generated from a physical model including a Flamant-Boussinesq approximation for vehicle-induced ground deformation and a one-dimensional Rayleigh scattering model for propagation of DAS signals in the optical fiber, thereby reducing dependency on real-world labeled datasets.

20. The non-transitory computer-readable medium of claim 19, wherein the DeCNN is based on a ResUnet++ architecture, and the one or more processors are further caused to upsample the preprocessed data to a spatial interval of 0.125 meters or finer prior to applying the DeCNN.
